(19) United States
(12) Patent Application Publication
(10) Pub. No.: US 2004/0011351 A1
(43) Pub. Date: Jan. 22, 2004

(54) Bread maker

(75) Inventors: Jae-ryong Park, Suwon city (KR); Jong-wook Lee, Yongin city (KR); Tae-uk Lee, Suwon city (KR); Han-jun Sung, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co. Ltd., Suwon-city (KR)

(21) Appl. No.: 10/385,495

(22) Filed: Mar. 12, 2003

(30) Foreign Application Priority Data
Jul. 19, 2002 (KR) 2002-42590

(51) Int. Cl. A23L 1/00; A47J 9/00

(52) U.S. Cl. 126/369; 99/348

(57) ABSTRACT

A bread maker including an oven compartment, kneading drums spacedly disposed in parallel inside the oven compartment, and a drum driving part rotating one of the kneading drums in clockwise and counterclockwise directions. Link shafts eccentrically project from the kneading drums and rotate about each respective rotation axis thereof. A connecting rod connects the link shafts and transmits a rotary movement between the kneading drums.

### CROSS-REFERENCE TO RELATED APPLICATIONS

This application claims the benefit of Korean Application No. 2002-42590, filed Jul. 19, 2002, in the Korean Intellectual Property Office, the disclosure of which is incorporated herein by reference.

### BACKGROUND OF THE INVENTION

1. Field of the Invention

The present invention relates to a bread maker, and more particularly, to a bread maker in which a rotary movement is transmitted between kneading drums.

2. Description of the Related Art

Generally, making bread is so complicated that it is difficult for an average person to make good bread at home. That is, making the bread is complicated because multiple steps are involved, including mixing raw materials such as flour, sugar, baking powder, etc. to form a dough; kneading the dough; leavening the dough; baking the dough; and so on.

Therefore, a bread maker has been developed that allows a user to easily make bread. The bread maker automatically performs the foregoing multiple steps and provides finished bread to the user.

For example, as shown in FIGS. 1 and 2, a bread maker disclosed in Korean Patent Application No. 2000-83355 includes a main body 100 divided into an oven compartment 110 and an electric component compartment 120, a door 300 in the front of the main body 100 to open and close the oven compartment 110, and a control panel (not shown) in the front of the electric component compartment 120 to allow a user to control the bread maker.

Inside the oven compartment 110, upper and lower kneading drums 111 and 113 are provided in parallel, onto which a bag (not shown) filled with raw materials for bread is attached and wound in clockwise and counterclockwise directions. The upper and lower kneading drums 111 and 113 have a plurality of projections 119 engaging a plurality of holes (not shown) in opposite ends of the bag.

Between the upper and lower kneading drums 111 and 113 is a baking tray 115 that contains the dough for baking. On the inside walls of the main body 100 and the door 300 are heaters 117 for heating the baking tray 115.

Beside the oven compartment 110 is the electric component compartment 120. Inside the electric component compartment 120 are a drum driving part 123, including a motor 123b incorporated with a gear reducer 123a to rotate the lower kneading drum 113 in clockwise and counterclockwise directions, and a belt 125 connecting the upper and lower kneading drums 111 and 113 to transmit a rotary movement from the lower kneading drum 113 to the upper kneading drum 111. The drum driving part 123 and the lower kneading drum 113 are connected by a coupler 121. Hence, the rotary movement of the drum driving part 123 is transmitted to the lower kneading drum 113, and the rotary movement of the lower kneading drum 113 is transmitted to the upper kneading drum 111 through the belt 125.

When the bag is attached to the upper and lower kneading drums 111 and 113 and the dough in the sealing bag is kneaded, the rotary movement is precisely transmitted from the lower kneading drum 113 to the upper kneading drum 111 in the ratio of 1:1 to prevent the bag from being split or loosened from the upper and lower kneading drums 111 and 113.

However, in the conventional bread maker, the belt 125 employed for transmitting the rotary movement from the lower kneading drum 113 to the upper kneading drum 111 is likely to become elongated over time or as it is heated by the heaters 117.

### SUMMARY OF THE INVENTION

It is an object of the present invention to provide a bread maker in which a rotary movement is precisely transmitted from a lower kneading drum to an upper kneading drum even though the bread maker may be used for a long time.

Additional objects and advantages of the invention will be set forth in part in the description that follows, and, in part, will be obvious from the description, or may be learned by practice of the invention.

To achieve the above and other objects according to an embodiment of the present invention, there is provided a bread maker having an oven compartment, kneading drums spacedly disposed in parallel inside the oven compartment, and a drum driving part rotating one of the kneading drums in clockwise and counterclockwise directions, including link shafts eccentrically projecting from the kneading drums about each respective rotation axis thereof; and a connecting rod connecting the link shafts and transmitting a rotary movement between the kneading drums.

Each link shaft projects from a side end of each kneading drum, the connecting rod is formed with a shaft hole in the ends of the connecting rod, and each link shaft is rotatably inserted in the respective shaft holes.

The bread maker further includes a wheel connected to each kneading drum and rotating therewith, wherein the link shafts are provided on the wheels.

To achieve the above and other objects according to another embodiment of the present invention, there is provided a bread maker having an oven compartment, kneading drums spacedly disposed in parallel inside the oven compartment, and a drum driving part rotating one of the kneading drums in clockwise and counterclockwise directions, including a wheel connected to each kneading drum and rotating therewith; a link shaft projecting from each wheel, each link shaft being located off-center on each respective wheel and rotating about a rotation axis of each respective kneading drum; and a connecting rod connecting the link shafts and transmitting a rotary movement between the kneading drums.

These together with other aspects and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

The above objects and other objects and advantages of the present invention will become apparent and more readily appreciated from the following description of the embodiments, taken in conjunction with the accompany drawings, of which:

FIG. 1 is a perspective view of a conventional bread maker;

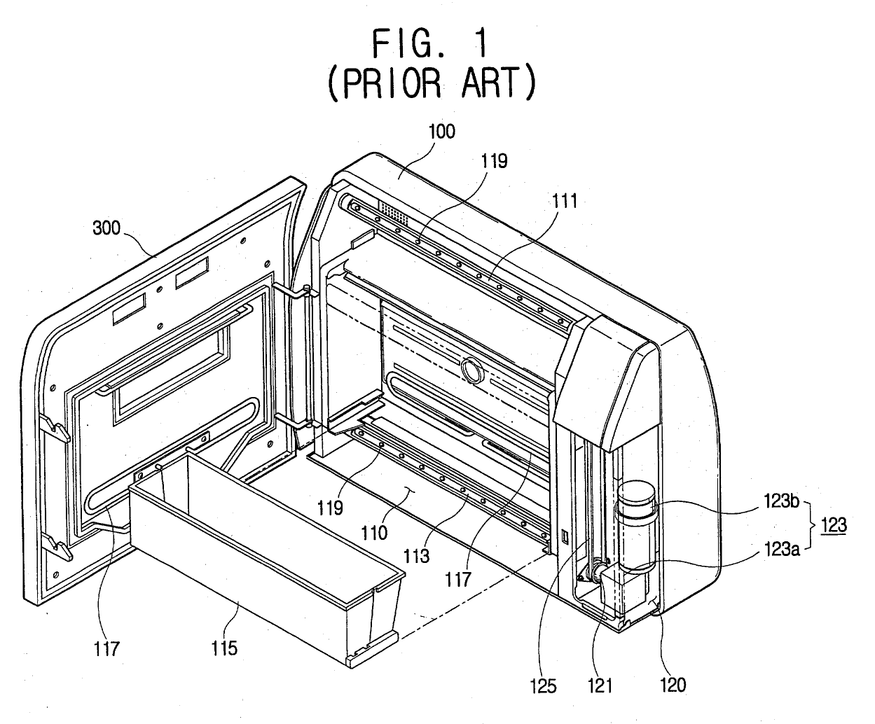

FIG. 2 is an enlarged perspective view of a component compartment of the conventional bread maker shown in FIG. 1;

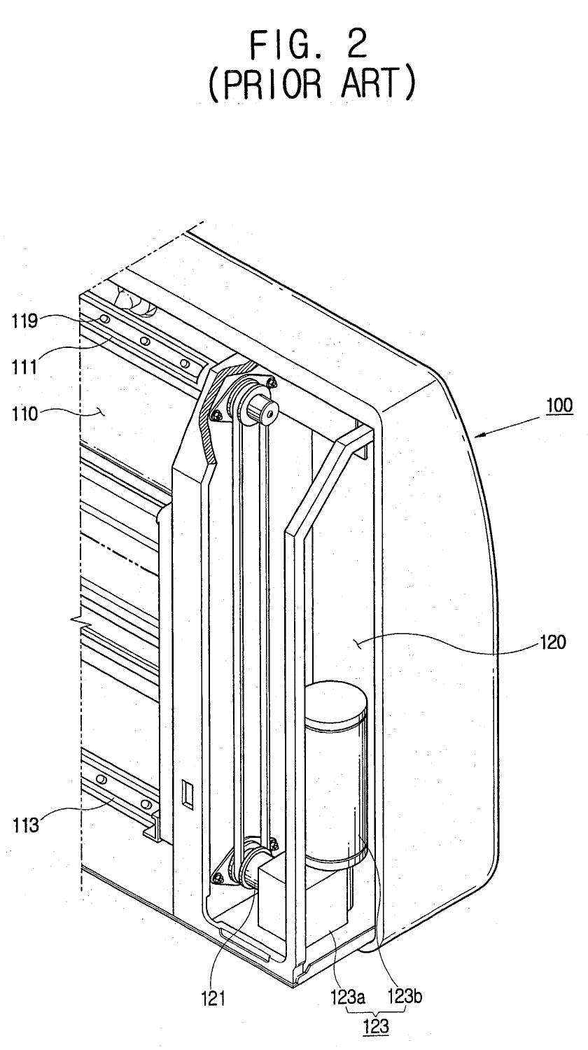

FIG. 3 is a perspective view of a bread maker according to a first embodiment of the present invention;

FIG. 4 is a front sectional view of the bread maker according to the first embodiment of the present invention shown in FIG. 3;

FIG. 5 is a side sectional view of the bread maker according to the first embodiment of the present invention shown in FIG. 3; and

FIG. 6 is a front sectional view of a bread maker according to a second embodiment of the present invention.

### DETAILED DESCRIPTION OF THE PREFERRED EMBODIMENT

Hereinafter, embodiments of the present invention will be described in detail with reference to the attached drawings, wherein the like reference numerals refer to the like elements throughout. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

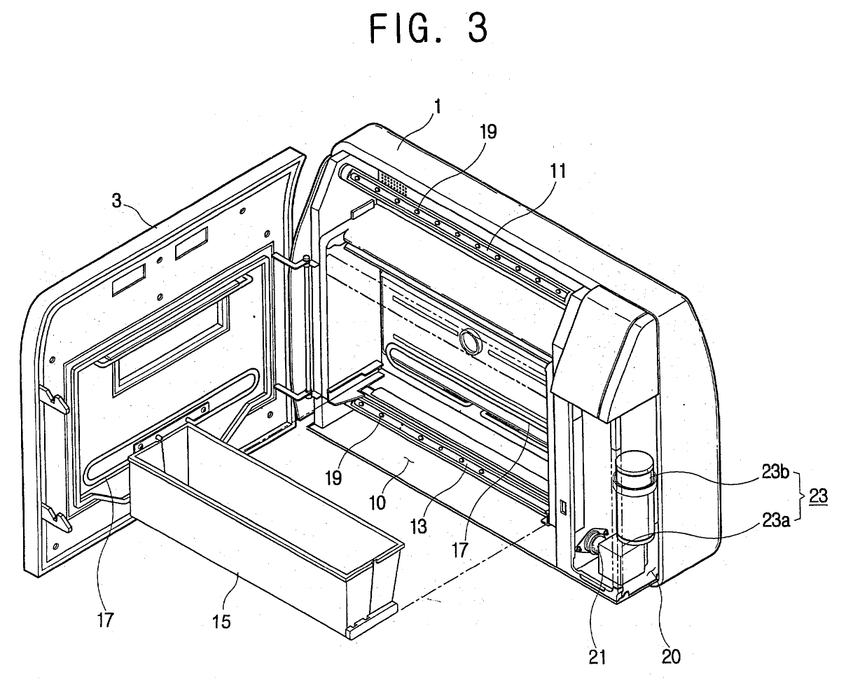

As shown in FIG. 3, a bread maker according to a first embodiment of the present invention includes a main body 1 with an oven compartment 10, a door 3 in the front of the main body 1 to open and close the oven compartment 10, and a control panel (not shown) in a front side of the main body 1 to allow a user to control the bread maker.

Inside the oven compartment 10, upper and lower kneading drums 11 and 13 are provided in parallel, onto which a bag (not shown) filled with raw materials for bread is attached and wound in clockwise and counterclockwise directions. The upper and lower kneading drums 11 and 13 are both provided with a plurality of projections 19 engaging a plurality of holes (not shown) in opposite ends of the bag.

Between the upper and lower kneading drums 11 and 13 is a baking tray 15 that contains the dough for baking. On the inside walls of the main body 1 and the door 3 are heaters 17 for heating the baking tray 15.

Beside the oven compartment 10 is an electric component compartment 20. Inside the electric component compartment 20 is a drum driving part 23, including a motor 23b incorporated with a gear reducer 23a to rotate the lower kneading drum 13 in clockwise and counterclockwise directions. The drum driving part 23 is connected to one side of the lower kneading drum 13 by a coupler 21.

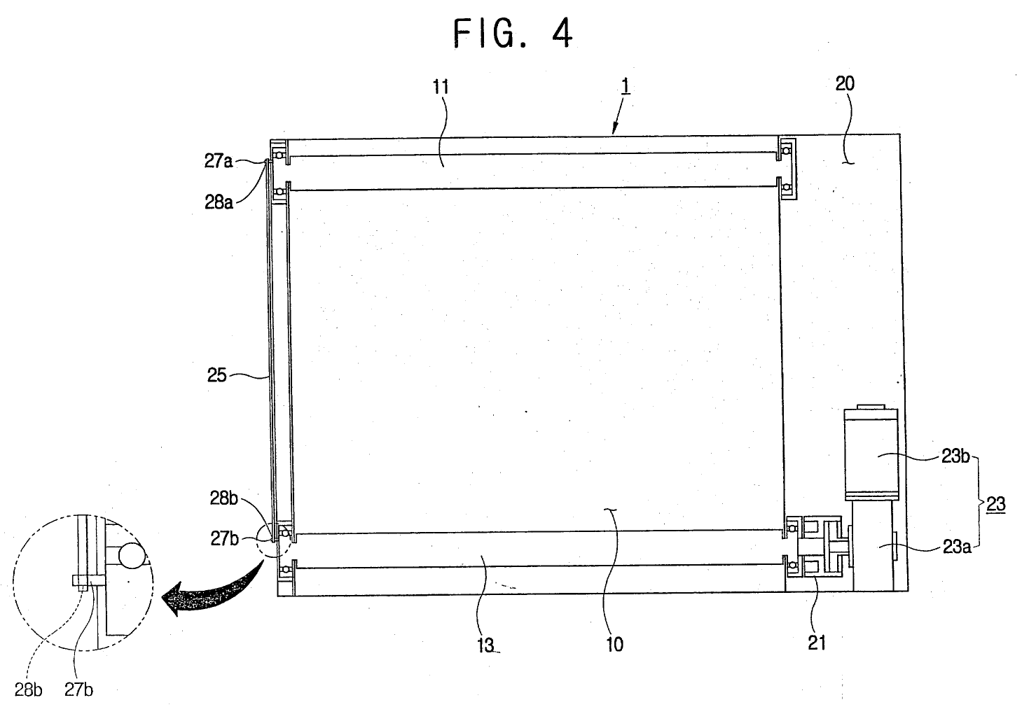

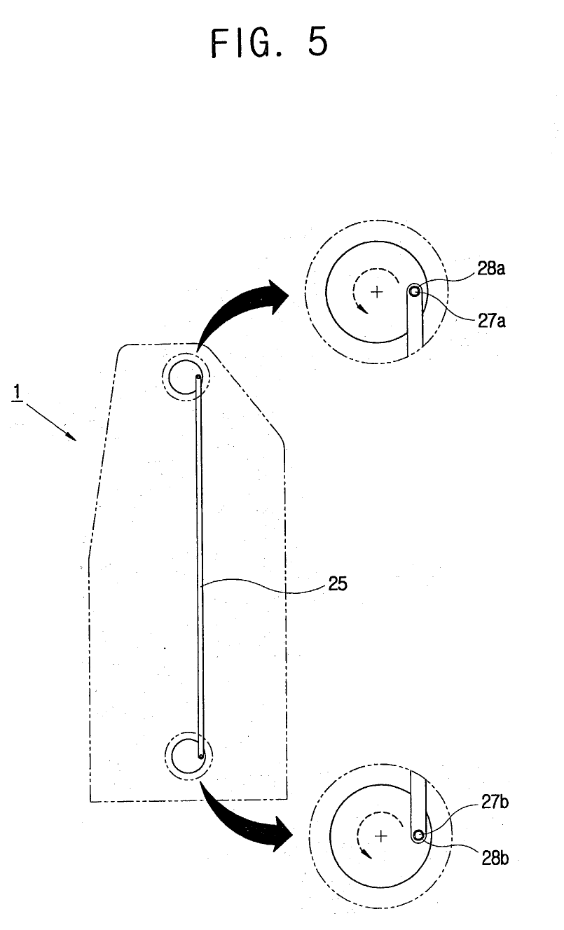

Referring to FIGS. 4 and 5, in the sides of the upper and lower kneading drums 11 and 13 opposite the electric component compartment 20, upper and lower link shafts 27a and 27b are eccentrically provided about each rotation axis of the upper and lower kneading drums 11 and 13, respectively. The upper and lower link shafts 27a and 27b are connected by a connecting rod 25.

The distance between the central axis of the upper kneading drum 11 and the upper link shaft 27a is equal to the distance between the central axis of the lower kneading drum 13 and the lower link shaft 27b. The rotating position of the upper link shaft 27a in the upper kneading drum 11 corresponds to the rotating position of the lower link shaft 27b in the lower kneading drum 13, as shown in FIG. 5.

In opposite ends of the connecting rod 25 are shaft holes 28a and 28b to which the upper and lower link shafts 27a and 27b are rotatably inserted.

Referring to FIG. 5, as the motor 23b rotates the lower kneading drum 13, the rotary movement is transferred from the lower kneading drum 13 through the connecting rod 25 to the upper kneading drum 11, so that the upper kneading drum 11 and the lower kneading drum 13 rotate together.

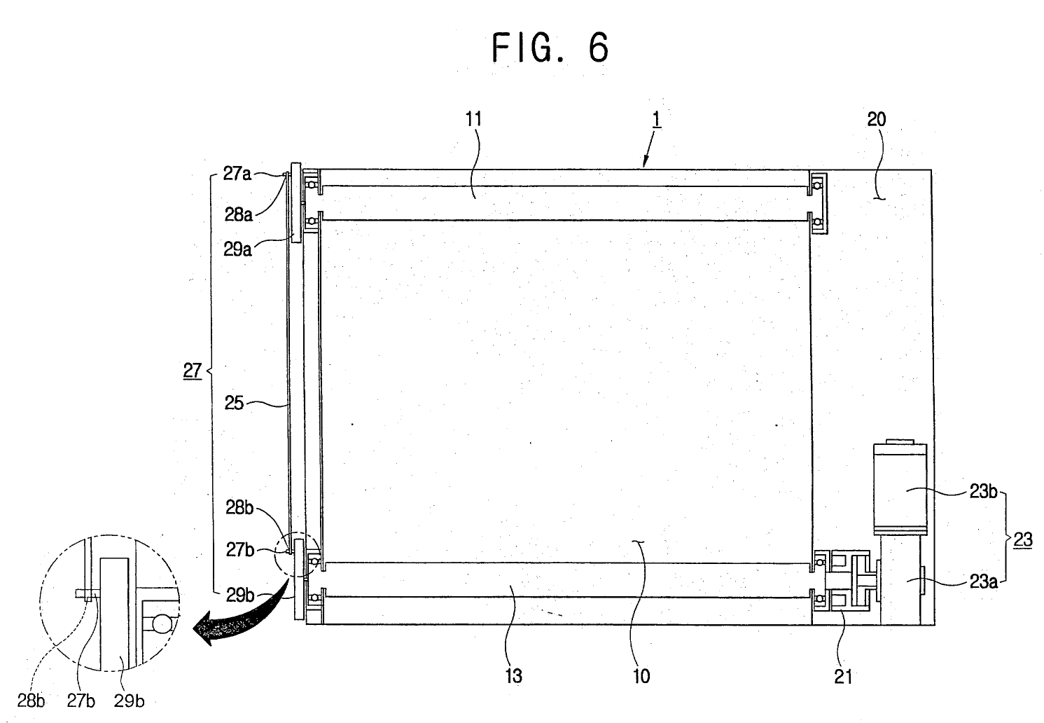

According to a second embodiment of the present invention as shown in FIG. 6, the upper and lower kneading drums 11 and 13 have wheels 29a and 29b attached, respectively. Upper and lower link shafts 27a and 27b are eccentrically provided on the respective wheels 29a and 29b about each rotation axis thereof. Thus, the upper and lower kneading drums 11 and 13 are part of a gear structure 27 that is not limited by a small radii of the upper and lower kneading drums 11 and 13.

In the foregoing embodiments, the upper and lower link shafts 27a and 27b are provided in the upper and lower kneading drums 11 and 13, and the shaft holes 28a and 28b are formed on the connecting rod 25. However, the upper and lower link shafts 27a and 27b may be provided in the connecting rod 25, and the shaft holes 28a and 28b may be formed on the upper and lower kneading drums 11 and 13.

As described above, the upper and lower kneading drums 11 and 13 are connected by the connecting rod 25, which does not deteriorate due to extended use and heat from the heaters 17. Thus, the rotary movement is precisely transmitted from the lower kneading drum 13 to the upper kneading drum 11.

As described above, the present invention provides a bread maker in which a rotary movement is precisely transmitted from a lower kneading drum to an upper kneading drum.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A bread maker having an oven compartment, kneading drums spacedly disposed in parallel inside the oven compartment, and a drum driving part rotating one of the kneading drums in clockwise and counterclockwise directions, comprising:
link shafts eccentrically projecting from the kneading drums about each respective rotation axis thereof; and
a connecting rod connecting the link shafts and transmitting a rotary movement between the kneading drums.

2. The bread maker according to claim 1, wherein each link shaft projects from a side end of each respective kneading drum, the connecting rod is formed with a shaft hole in the ends of the connecting rod, and each link shaft is rotatably inserted in the respective shaft holes.

3. The bread maker according to claim 1, further comprising a wheel connected to each kneading drum and rotating therewith, wherein the link shafts are provided on the wheels.

4. The bread maker according to claim 1, wherein the kneading drums have a plurality of projections and a bag filled with ingredients for bread is attached to the projections and wound in clockwise and counterclockwise directions.

5. The bread maker according to claim 1, wherein the drum driving part includes a motor and a gear reducer.

6. The bread maker according to claim 1, further comprising a coupler connecting the drum driving part to the kneading drum that is rotated by the drum driving part.

7. The bread maker according to claim 1, wherein the kneading drums comprise an upper kneading drum and a lower kneading drum, and a distance between a central axis of the upper kneading drum and the link shaft connected thereto is substantially the same as a distance between a central axis of the lower kneading drum and the link shaft connected thereto.

8. The bread maker according to claim 1, wherein the kneading drums comprise an upper kneading drum and a lower kneading drum, and a rotating position of the link shaft connected to the upper kneading drum corresponds to a rotating position of the link shaft connected to the lower kneading drum.

9. A method of transmitting a rotary movement between kneading drums of a bread maker, comprising:
eccentrically locating link shafts in the kneading drums, the link shafts rotating about a rotation axis of each respective kneading drum;
connecting the link shafts with a connecting rod; and
rotating one of the kneading drums and transmitting a rotary movement from the rotating kneading drum to the other kneading drum through the connecting rod and the link shafts.

10. The method according to claim 9, wherein the kneading drums comprise an upper kneading drum and a lower kneading drum, and a distance between a central axis of the upper kneading drum and the link shaft connected thereto is substantially the same as a distance between a central axis of the lower kneading drum and the link shaft connected thereto.

11. The method according to claim 9, wherein the kneading drums comprise an upper kneading drum and a lower kneading drum, and a rotating position of the link shaft connected to the upper kneading drum corresponds to a rotating position of the link shaft connected to the lower kneading drum.

12. A bread maker having an oven compartment, kneading drums spacedly disposed in parallel inside the oven compartment, and a drum driving part rotating one of the kneading drums in clockwise and counterclockwise directions, comprising:
a wheel connected to each kneading drum and rotating therewith;
a link shaft projecting from each wheel, each link shaft being located off-center on each respective wheel and rotating about a rotation axis of each respective kneading drum; and
a connecting rod connecting the link shafts and transmitting a rotary movement between the kneading drums.

13. The bread maker according to claim 12, wherein the kneading drums have a plurality of projections and a bag filled with ingredients for bread is attached to the projections and wound in clockwise and counterclockwise directions.

14. The bread maker according to claim 12, wherein the drum driving part comprises a motor and a gear reducer.

15. The bread maker according to claim 12, further comprising a coupler connecting the drum driving part to the kneading drum that is rotated by the drum driving part.

16. The bread maker according to claim 12, wherein the wheels comprise an upper wheel and a lower wheel, and a distance between a central axis of the upper wheel and the link shaft connected thereto is substantially the same as a distance between a central axis of the lower wheel and the link shaft connected thereto.

17. The bread maker according to claim 12, wherein the wheels comprise an upper wheel and a lower wheel, and a rotating position of the link shaft connected to the upper wheel corresponds to a rotating position of the link shaft connected to the lower wheel.

18. The bread maker according to claim 12, wherein each end of the connecting rod contains shaft holes into which respective link shafts are inserted.

19. A method of transmitting a rotary movement between kneading drums of a bread maker, comprising:
connecting a wheel to each kneading drum;
projecting a link shaft from each wheel, each link shaft being eccentrically located on each respective wheel and rotating about a rotation axis of each respective kneading drum; and
connecting the link shafts with a connecting rod; and
rotating one of the kneading drums and transmitting a rotary movement from the rotating kneading drum to another kneading drum through the connecting rod and the wheels.

20. The method according to claim 19, wherein the wheels comprise an upper wheel and a lower wheel, and a distance between a central axis of the upper wheel and the link shaft connected thereto is substantially the same as a distance between a central axis of the lower wheel and the link shaft connected thereto.

21. The method according to claim 19, wherein the wheels comprise an upper wheel and a lower wheel, and a rotating position of the link shaft connected to the upper wheel corresponds to a rotating position of the link shaft connected to the lower wheel.

22. A bread maker having an oven compartment, kneading drums spacedly disposed in parallel inside the oven compartment, and a drum driving part rotating one of the kneading drums in clockwise and counterclockwise directions, comprising:
a connecting rod connecting the kneading drums and transmitting a rotary movement between the kneading drums; and
link shafts respectively projecting from each end of the connecting rod and eccentrically attached to respective ones of the kneading drums about each respective rotation axis thereof.

23. The bread maker according to claim 22, further comprising shaft holes formed in respective ends of each kneading drum into which respective ones of the link shafts are inserted.

24. A bread maker having an oven compartment, kneading drums spacedly disposed in parallel inside the oven compartment, and a drum driving part rotating one of the kneading drums in clockwise and counterclockwise directions, comprising:
a wheel connected to each kneading drum and rotating therewith;
a connecting rod connecting the wheels and transmitting a rotary movement between the kneading drums; and
a link shaft projecting from each end of the connecting rod and eccentrically attached to respective ones of the wheels about a respective rotation axis thereof.

25. A bread maker, comprising:
a main body;
an oven compartment within the main body;
a door opening and closing the oven compartment;
a control panel in the main body to control the bread maker;
an upper kneading drum and a lower kneading drum spacedly disposed in parallel inside the oven compartment, and having a plurality of projections onto which a mixing bag is attached, the upper kneading drum and the lower kneading drum rotating to knead contents of the mixing bag;
a baking tray between the upper kneading drum and the lower kneading drum receiving the kneaded contents of the mixing bag;
heaters in the door and the oven compartment to heat the baking tray;
an electric component compartment having a drum driving part connected to one of the kneading drums to rotate the connected kneading drum in clockwise and counterclockwise directions;
link shafts eccentrically located on the kneading drums about each respective rotation axis thereof; and
a connecting rod connecting the link shafts and transmitting a rotary movement between the kneading drums.

26. The bread maker according to claim 25, wherein the drum driving part includes a motor and a gear reducer.

27. The bread maker according to claim 25, further comprising a coupler connecting the drum driving part to the kneading drum that is rotated by the drum driving part.

28. The bread maker according to claim 25, wherein a distance between a central axis of the upper kneading drum and the link shaft connected thereto is substantially the same as a distance between a central axis of the lower kneading drum and the link shaft connected thereto.

29. The bread maker according to claim 25, wherein a rotating position of the link shaft connected to the upper kneading drum corresponds to a rotating position of the link shaft connected to the lower kneading drum.

30. The bread maker according to claim 25, wherein each end of the connecting rod contains shaft holes into which respective link shafts are inserted.
